(19) United States
(12) Patent Application Publication
(10) Pub. No.: US 2022/0252190 A1
(43) Pub. Date: Aug. 11, 2022

(54) CONNECTION STRUCTURE OF METAL CORRUGATED PIPE

(71) Applicant: DooBon Flexible Co., LTD, Gimpo-si (KR)

(72) Inventor: Hwa-ok SHIN, Goyang-si (KR)

(21) Appl. No.: 17/666,253

(22) Filed: Feb. 7, 2022

(30) Foreign Application Priority Data
Feb. 9, 2021 (KR) 10-2021-18430

(51) Int. Cl. F16L 19/02; F16L 19/025

(52) U.S. Cl. CPC F16L 19/0218; F16L 19/025

(57) ABSTRACT

Provided is a connection structure of a metal corrugated pipe, including: a first connection member including a first connection member inner guide straight pipe and a first connection member inner inclined pipe; the metal corrugated pipe inserted into the first connection member inner guide straight pipe and the first connection member inner inclined pipe of the first connection member; a second connection member fitted on an outer side of the metal corrugated pipe, and screw-coupled to the first connection member; a metal packing fitted on the outer side of the metal corrugated pipe, and inserted into the first connection member inner guide straight pipe and the first connection member inner inclined pipe so as to be pipe-reduced to form a curved surface; and a separation prevention ring configured to fix the metal packing to prevent the metal packing from being separated.

### BACKGROUND OF THE INVENTION

### 1. Field of the Invention

One aspect of the present disclosure relates to a connection structure of a metal corrugated pipe, and more particularly, to a connection structure of a metal corrugated pipe, which is a connection structure for connecting the metal corrugated pipe used for transferring a fluid in a boiler or the like by two connection members that are screw-coupled to each other, in which a metal packing is formed on an outer side of the metal corrugated pipe, the two connection members are coupled to each other on an outer side of the metal packing, and the metal packing is contracted by a coupling force of the two connection members, so that a leakage of the fluid may be prevented.

### 2. Description of the Related Art

In general, a metal corrugated pipe may be formed in a corrugated shape in which crests and roots are consecutively repeated in a longitudinal direction, and since the metal corrugated pipe is easily bent at a desired angle due to an outer surface having a corrugated structure, the metal corrugated pipe may be used as a pipe for various purposes.

Such a metal corrugated pipe may be mainly used as a supply pipe for supplying a gas to a boiler, an oven, a dryer, a heater, or the like, which usethe gas as a fuel.Therefore, since the metal corrugated pipe is used in high-temperature devices, the metal corrugated pipe may be formed of a material having an excellent heatresistance to withstand high temperatures.

Meanwhile, the metal corrugated pipe may be connected to another metal corrugated pipe, or may be directly connected to a device such as a boiler.

In order to connect the metal corrugated pipe described above to another metal corrugated pipe or the device such as a boiler, two connection members having screw threadsmay be screw-coupled to each other on an outer side of an end portion of the metal corrugated pipe, and a fixing device for preventing the metal corrugated pipe from escaping from the two connection members connected to each other may be additionally provided.

As the relate art having the above configuration, Korean Utility Model No. 20-1995-0033769 discloses that: a steep taper surface and a gradual taper surface are formed insidean end portion of a socket pipe; a silicone packing has an outer surface compressed on the steep taper surface and the gradual taper surface of the socket pipe, and an inner surface compressed over a cladding body and a corrugated pipe outer surface of acladding corrugated pipe; a metal ring for contracting a root of the corrugated pipe while compressing the silicone packing has an open ring shape having an irregularcircular section; and a ring contact surface of a tightening nut makes line contact with the metal ring.

However, since the related art corresponds to a scheme in which the packing is formed of a soft material to fill the root of the corrugated pipe, it may be difficult to apply the related art to the field dealing with high-temperature and high-pressure facilities, and the soft material may be hardened to cause an intrinsic modulus of elasticity to be reduced when compressed for a long time so that maintenance of airtightness may deteriorate due to external impacts and vibrations.

### DOCUMENTS OF RELATED ART

### Patent Documents

(Patent document 0001) Korean Unexamined Utility Model Publication No. 20-1995-0033769 (published on Dec. 18, 1995), “Cladding Metal Corrugated Pipe Joint”

### SUMMARY OF THE INVENTION

To solve the problems described above, an object of one aspect of the present disclosure is to provide a connection structure of a metal corrugated pipe, which is a connection structure for connecting the metal corrugated pipe by two connection members that are screw-coupled to each other, in which a metal packing is formed on an outer side of the metal corrugated pipe, the two connection members are coupled to each other on an outer side of the metal packing, the metal packing is contracted by a coupling force of the two connection members, and an inner periphery of one connection member has a diameter reduced to form a curved surface so as to allow the metal packing coupled to the one connection member to also be pipe-reduced to form a curved surface, so that a leakage of water, a liquid, a gas, or the like may be effectively prevented.

In addition, an object of one aspect of the present disclosure is to provide a connection structure of a metal corrugated pipe, in which a friction surface is formed on an end surface of the metal packing, a separation prevention ring, and an inclined surface of one connection member, so that coupling may be performed with sliding friction between an outer surface of the metal packing and the inclined surface of the connection member as the remaining connection member is pulled based on the separation prevention ring by a rotation of the one connection member.

To achieve the objects described above, according to one aspect of the present disclosure, there is provideda connection structure of a metal corrugated pipe, the connection structure including: a first connection member including a first connection member screw thread formed on one side of an outer peripheral surface of the first connection member, and including a first connection member inner guide straight pipe and a first connection member inner inclined pipe, which are formed on an inner side of a region in which the first connection member screw thread is formed; the metal corrugated pipe inserted into the first connection member inner guide straight pipe and the first connection member inner inclined pipe of the first connection member; a second connection member fitted on an outer side of the metal corrugated pipe, screw-coupled to the first connection member, and including a second connection member screw thread, and a second connection member inclined surface or a second connection member perpendicular surface, which are formed on an inner side of the second connection member; a metal packing fitted on the outer side of the metal corrugated pipe, and inserted into the first connection member inner guide straight pipe and the first connection member inner inclined pipe so as to be pipe-reduced to foLm a curved surface; and a separation prevention ring fitted in a root formed on the outer side of the metal corrugated pipe, and configured to fix the metal packing to prevent the metal packing from being separated.

In addition, the metal packing may be formed of a metal material including copper.

In addition, the first connection member inner guide straight pipe and the first connection member inner inclined pipe of the first connection member may have diameters reduced to form curved surfaces in an inward direction in which the metal corrugated pipe is inserted.

In addition, a first connection member guide straight surface and a first connection member inclined surface may be foamed on inner walls of the first connection member inner guide straight pipe and the first connection member inner inclined pipe, respectively.

In addition, the metal packing may be inserted into the first connection member inner guide straight pipe and the first connection member inner inclined pipe so as to have a diameter reduced to foam the curved surface.

In addition, the metal corrugated pipe may have a diameter reduced to form a curved surface by the metal packing that is pipe-reduced to form the curved surface.

In addition, a friction surface may be formed on an end surface of the metal packing, the separation prevention ring, and the second connection member inclined surface, so that the metal packing is inserted into a first connection member inclined surface so as to be pipe-reduced as the first connection member is pulled toward the separation prevention ring based on the separation prevention ring by rotating the second connection member.

According to the connection structure of the metal corrugated pipe of one aspect of the present disclosure, which is a connection structure for connecting the metal corrugated pipe by two connection members that are screw-coupled to each other, a metal packing is formed on an outer side of the metal corrugated pipe, the two connection members are coupled to each other on an outer side of the metal packing, the metal packing is contracted by a coupling force of the two connection members, and an inner periphery of one connection member has a diameter reduced to form a curved surface so as to allow the metal packing coupled to the one connection member to also be pipe-reduced to faun a curved surface, so that a leakage of water, a liquid, a gas, or the like can be prevented more effectively.

In addition, according to the connection structure of the metal corrugated pipe of one aspect of the present disclosure, a friction surface is formed on an end surface of the metal packing, a separation prevention ring, and an inclined surface of one connection member, so that the metal packing can be inserted into a first connection member guide straight pipe and a first connection member inclined surface while exhibiting sliding friction with the first connection member guide straight pipe and the first connection member inclined surfaceas a second connection member is coupled to a first connection member based on the separation prevention ring by rotating the second connection member, and thus the metal packing can be pipe-reduced, and the metal corrugated pipe can also be pipe-reduced by a pipe-reducing force of the metal packing so as to allow the metal corrugated pipe to make close contactwith the metal packing.

### BRIEF DESCRIPTION OF THE DRAWINGS

FIG. 1 is a perspective view showing a state before a connection structure of a metal corrugated pipe according to an embodiment of the present invention is coupled.

FIG. 2 is a sectional view showing the state before the connection structure of the metal corrugated pipe according to the embodiment of the present invention is coupled.

FIG. 3 is a sectional view showing a first connection member according to the embodiment of the present invention.

FIG. 4 is a sectional view showing a second connection member according to the embodiment of the present invention.

FIG. 5 is a perspective view showing a state in which the connection structure of the metal corrugated pipe according to the embodiment of the present invention is coupled.

FIG. 6 is a sectional view showing the state in which the connection structure of the metal corrugated pipe according to the embodiment of the present invention is coupled.

### DETAILED DESCRIPTION OF THE INVENTION

The following detailed descriptions of the present disclosure are given for embodiments in which the present disclosure may be practiced, and refer to the accompanying drawings that illustrate the embodiments. These embodiments are described in sufficient detail to enable those skilled in the art to practice the present disclosure. It is to be understood that various embodiments of the present disclosure are different from each other, but need not be mutually exclusive. For example, specific shapes, structures, and characteristics described herein may be implemented and changed from one embodiment to another embodiment without departing from the idea and scope of the present disclosure. In addition, it is to be understood that positions or arrangements of individual elements in each embodiment described herein may vary without departing from the idea and scope of the present disclosure.

Therefore, the following detailed description is not to be taken in a limiting sense, and the scope of the disclosure is defined only by the appended claims while encompassing the scope of all equivalents of the claimed disclosure when appropriately described. In the drawings, like reference numerals refer to elements that perform the same or similar functions in various aspects.

Regarding the terms used herein, general terms that are currently used as widely as possible are selected in consideration of functions thereof in the present disclosure. However, the meanings of the terms may vary according to the intention of those skilled in the art, judicial precedents, the emergence of new technologies, and the like. In addition, in certain cases, a term may be selected at discretion of the applicant. In this case, the meaning of the term will be described in detail at a corresponding part in the description of the disclosure. Therefore, the terms used herein are to be defined based on the meanings of the terms and the contents throughout the present disclosure without being simply limited to names of the terms.

In the present disclosure, when some part “includes” some elements, unless explicitly described to the contrary, it means that other elements may be further included but not excluded. Hereinafter, a connection structure of a metal corrugated pipe for connecting a metal corrugated pipe P to another metal corrugated pipe or a device such as a boiler will be described in detail with reference to the accompanying drawings.

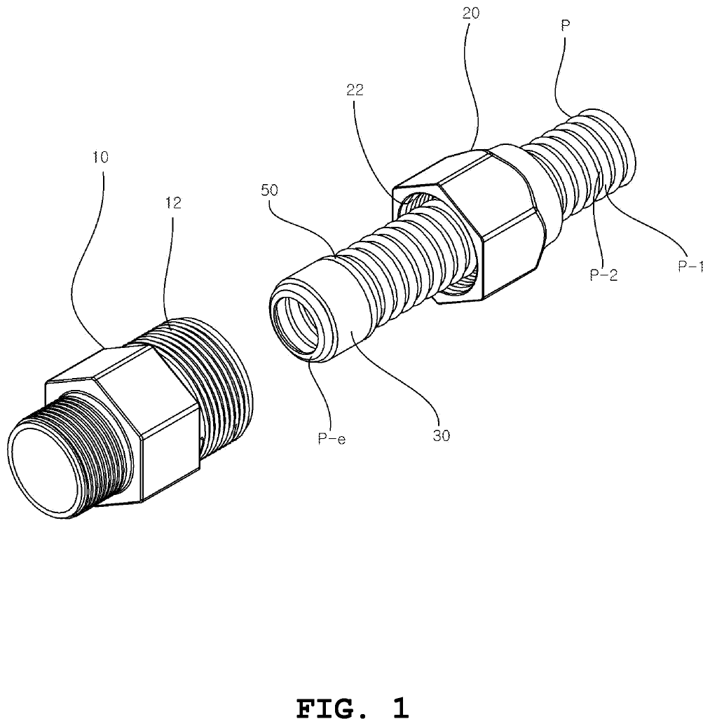

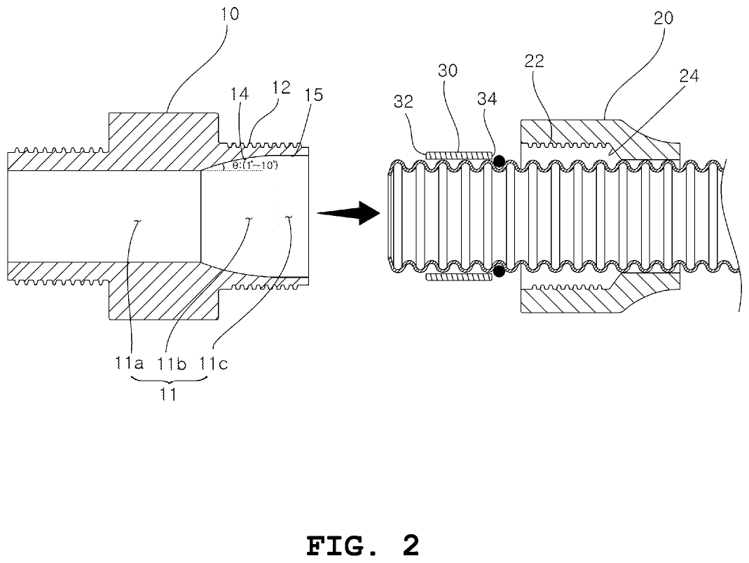

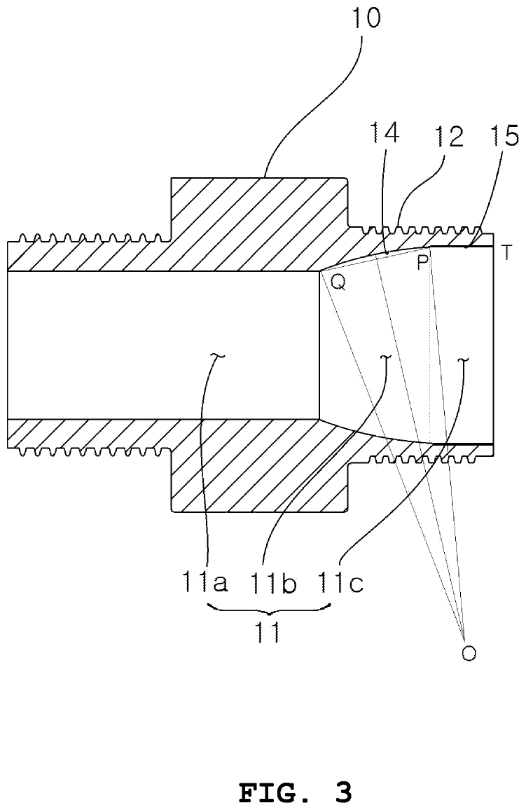

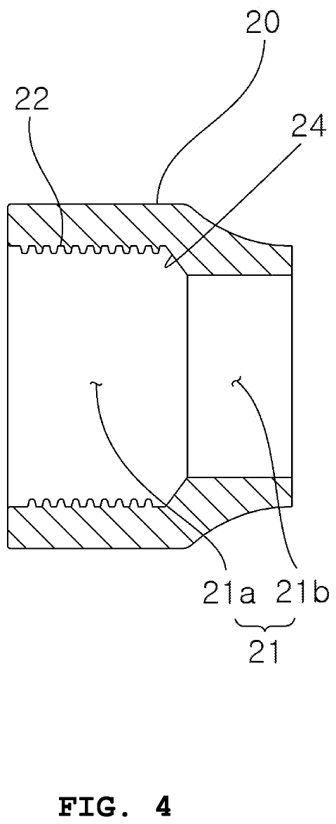

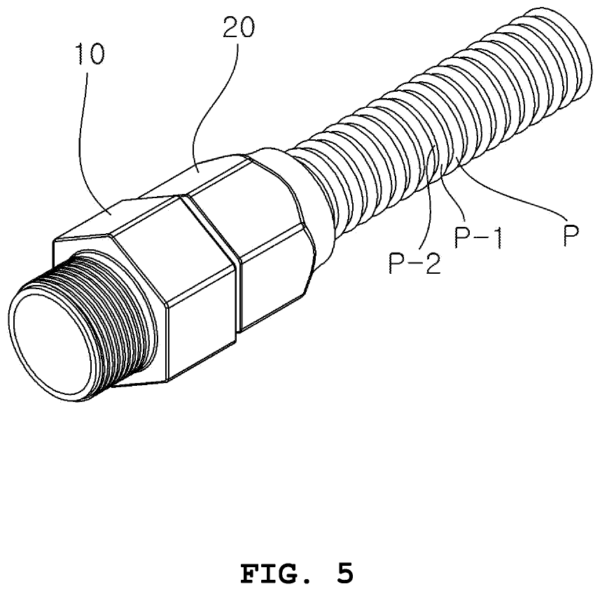

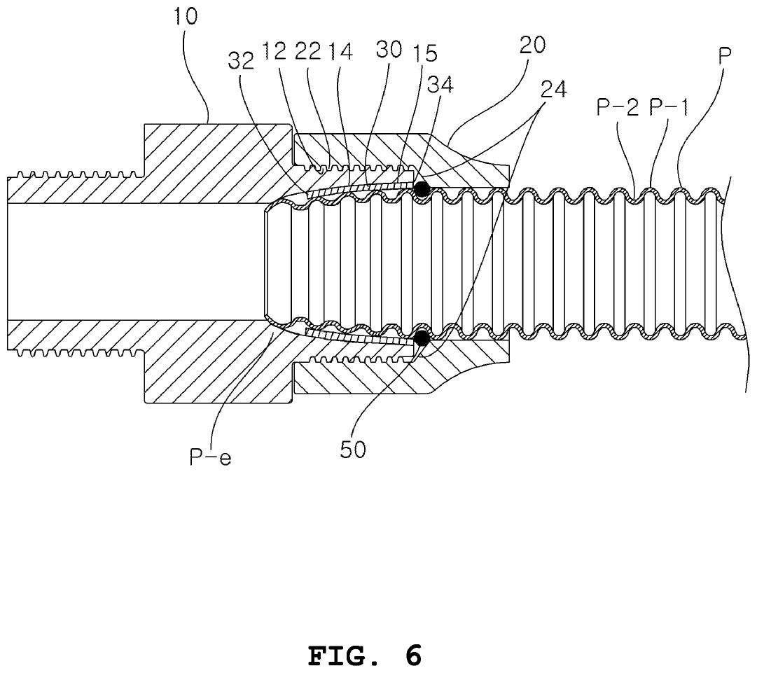

FIG. 1 is a perspective view showing a state before a connection structure of a metal corrugated pipe according to an embodiment of the present invention is coupled, FIG. 2 is a sectional view showing the state before the connection structure of the metal corrugated pipe according to the embodiment of the present invention is coupled, FIG. 3 is a sectional view showing a first connection member according to the embodiment of the present invention, FIG. 4 is a sectional view showing a second connection member according to the embodiment of the present invention, FIG. 5 is a perspective view showing a state in which the connection structure of the metal corrugated pipe according to the embodiment of the present invention is coupled, and FIG. 6 is a sectional view showing the state in which the connection structure of the metal corrugated pipe according to the embodiment of the present invention is coupled.

As shown FIGS. 1 to 6, according to one aspect of the present disclosure, the connection structure of the metal corrugated pipe may include: a first connection member 10 including a first connection member screw thread 12 formed on one side of an outer peripheral surface of the first connection member 10, and including a first connection member inner guide straight pipe 11c and a first connection member inner inclined pipe 11b, which are formed on an inner side of a region in which the first connection member screw thread 12 is formed;a metal corrugated pipe P inserted into the first connection member inner guide straight pipe 11c and the first connection member inner inclined pipe 11b of the first connection member 1); a second connection member 20 fitted on an outer side of the metal corrugated pipe P, screw-coupled to the first connection member 10, and including a second connection member screw thread 22, and a second connection member inclined surface 24 or a second connection member perpendicular surface (not shown), which are formed on an inner side of the second connection member 20; a metal packing 30 fitted on the outer side of the metal corrugated pipe P, and inserted into the first connection member inner guide straight pipe 11c and the first connection member inner inclined pipe 11b so as to be pipe-reduced to form a curved surface; and a separation prevention ring 50 fitted in a root P-2 formed the outer side of the metal corrugated pipe P, and configured to fix the metal packing 30 to prevent the metal packing 30 from being separated.

The first connection member 10 may have a configuration into which the metal corrugated pipe P and the metal packing 30 are inserted so as to be fixed. The first connection member 10 may have a tubular shape so that the metal corrugated pipe P and the metal packing 30 may be inserted into the first connection member 10 so as to be fixed.

In addition, the first connection member screw thread 12 for coupling the first connection member 10 to the second connection member 20 may be formed on one side of an outer periphery of the first connection member 10.

Meanwhile, as shown in FIGS. 2 to 3, a first connection member inner pipe 11 may be formed inside the first connection member 10, in which the first connection member inner pipe 11 may be divided into a first connection member inner straight pipe 11a having a sectional shape of a straight line, a first connection member inner inclined pipe 11b having a tapered sectional shape, and a first connection member inner guide straight pipe 11c that serves as a guide for the metal packing 30 and has a straight pipe shape.

An inclined section may be formed by the first connection member inner guide straight pipe 11c and the first connection member inner inclined pipe 11b, and as shown in FIG. 2, an angle of the inclined section is preferably 1° to 10° with respect to the first connection member inner straight pipe 11a. This is to ensure that the metal packing 30 and the metal corrugated pipe P may be compressed against the first connection member 10 to firmly make close contact the first connection member 10 according to an inclined shape of the first connection member inner inclined pipe 11b.

When the angle is greater than 10°, the metal packing 30 and the metal corrugated pipe P may not be pipe-reduced, and when the angle is less than 1°, airtightness may not be ensured due to insufficient close contact strength between the metal packing 30 and the metal corrugated pipe P, which are pipe-reduced.

In summary, the first connection member inner inclined pipe 11b having a diameter that is gradually reduced in a direction in which the metal corrugated pipe P is inserted into the first connection member 10 is preferably formed on one side of the first connection member inner pipe 11 formed in the first connection member 10 to which the metal corrugated pipe P is coupled.

In addition, the first connection member inner guide straight pipe 11c may be adjacent to the first connection member inner inclined pipe 11b, in which the first connection member inner guide straight pipe 11c is preferably formed at a portion of the first connection member inner pipe 11 that is initially coupled to the metal corrugated pipe P. This is to guide an insertion direction of the metal packing 30 and the metal corrugated pipe P through the first connection member inner guide straight pipe 11c. A first connection member guide straight surface 15 may be formed on an inner wall of the first connection member inner straight pipe 11a.

In more detail, the first connection member inner straight pipe 11a and the first connection member inner guide straight pipe 11c may be formed on opposite sides of the first connection member inner inclined pipe 11b, respectively.In other words, the first connection member inner guide straight pipe 11c, the first connection member inner inclined pipe 11b, and the first connection member inner straight pipe 11a may be sequentially formed in the first connection member 10 in a direction in which the metal packing 30 and the metal corrugated pipe P are inserted.

Meanwhile, a first connection member inclined surface 14 may be formed on an inner wall of the first connection member inner inclined pipe llb formed in the first connection member 10. In other words, the first connection member inclined surface 14 may refer to the inner wall of the first connection member inner inclined pipe 11b. The first connection member inclined surface 14 preferably has a tapered sectional shape in the direction in which the metal corrugated pipe P is inserted into the first connection member 10. Meanwhile, an inner wall of the first connection member inner guide straight pipe 11c also preferably has a tapered shape in the direction in which the metal corrugated pipe P is inserted into the first connection member 10.

Meanwhile, the first connection member inner inclined pipe lib may have a sectional shape of a curved pipe. In other words, the first connection member inclined surface 14 may have a curved surface shape. This is to ensure that the metal corrugated pipe P and the metal packing 30 inserted into the first connection member inclined surface 14 may be bent in a curved surface shape by the first connection member inclined surface 14 so as to be pipe-reduced.

Meanwhile, the first connection member inclined surface 14 may have a uniformly bent sectional shape.

Therefore, the metal packing 30 and the metal corrugated pipe P that are pipe-reduced may become longer than original lengths thereof by a pipe-reduced ratio. As shown in FIG. 3, with respect to a section of the first connection member inclined surface 14, a point at which the first connection member inner guide straight pipe 11c starts may be referred to as a first connection member inner guide straight pipe start point T, a point at which the first connection member inclined surface 14 starts may be referred to as a first connection member inclined surface start point P, and a point at which the first connection member inclined surface ends may be referred to as a first connection member inclined surface end point Q. Accordingly, assuming that the section of the first connection member inclined surface 14 matches a part of a circle, a sector may be formed, and a virtual center point O may be formed.

Then, according to a bending degree of the section of the first connection member inclined surface 14, a size of the circle defined by using the first connection member inclined surface 14 may also vary, and a positon of the virtual center point O may also vary. In this case, each of a length OP between the virtual center point O and the first connection member inclined surface start point P and a length OQ between the virtual center point O and the first connection member inclined surface end point Q may be referred to as a radius of curvature.

A curvature is a reciprocal of the radius of curvature. According to one aspect of the present disclosure, the curvature of the section of the first connection member inclined surface 14 may be expressed as PQ/OP or PQ/OQ with respect to a virtual sectorOPQ.

Accordingly, according to one aspect of the present disclosure, the first connection member inclined surface 14 preferably has a curvature of 1/10,000 to 1/200. In other words, according to one aspect of the present disclosure, the first connection member inclined surface 14 preferably has the curvature of 0.00001 to 0.005. This corresponds to almost a straight line. However, it is to be noted that a curved surface has been somewhat exaggerated in the drawings for a better understanding.

For example, when a linear length of the PQ is 10 mm, a radius of the virtual sector formed along the curved surface of the first connection member inclined surface 14 is preferably 2,000 mm to 100,000 mm.In addition, when the linear length of the PQ is 20 mm, the radius of the virtual sector formed along the curved surface of the first connection member inclined surface 14 is preferably 4,000 mm to 200,000 mm.

In summary, a shape of the section of the first connection member inclined surface 14 may match a part of a circle, and a linear distance between the first connection member inclined surface start point P and the first connection member inclined surface end point Q of the first connection member inclined surface may be 1/10,000 to 1/200 with respect to a length of the radius OP or OQ of the virtual sector OPQ formed by using the first connection member inclined surface 14 having a shape that matches the part of the circle.

Since the first connection member inclined surface 14 has the curvature of 1/10,000 to 1/200, the metal packing 30 and the metal corrugated pipe P may be bent to correspond to the first connection member inclined surface 14, so that optimal close contact strength in which a fluid such as water, a liquid, or a gas is prevented from leaking from the first connection member 10, the metal packing 30, and the metal corrugated pipe P may be obtained.

Since the first connection member inclined surface 14 makes contact with the metal packing 30 and the metal corrugated pipe P to form the curved surface, it may be difficult for the fluid such as water, a liquid, or a gas to move through a gap between the first connection member inclined surface 14 and the metal packing 30, and the metal corrugated pipe P, and acoupling force between componentsmay be strengthened, so that separation of the components caused by an external force or an internal pressure may also be minimized.

For example, even when the second connection member 20 is completely separated after the first connection member 10, the metal packing 30, and the metal corrugated pipe P are coupled through the second connection member 20, it was found that the first connection member 10 and the metal packing 30, and the metal corrugated pipe P are maintained in a completely coupled state. Even when the second connection member 20 is completely removed for use, it was found that there is no difficulty in transferring the fluid such as water, a liquid, or a gas.

The metal corrugated pipe P may have a tubular shape foLmed therein with an empty space, and may be configured to transfer the fluid such as water, a liquid, or a gas.

The metal corrugated pipe P is preferably formed of a metal material to transfer a high-temperature gas or the like. In more detail, the metal corrugated pipe P may be formed of a material such as copper, aluminum, stainless steel, or the like.

Meanwhile, a crest P-1 and a root P-2 may be formed in the metal corrugated pipe P to allow the metal corrugated pipe P to be easily bent at an angle. One cut end portion of the metal corrugated pipe P may be referred to as a metal corrugated pipe end portion P-e.

The metal corrugated pipe end portion P-e may be inserted into and coupled to the first connection member inner inclined pipe llb of the first connection member 10. Meanwhile, the second connection member 20 may be screw-coupled to the first connection member 10. The second connection member screw thread 22 may be formed on the second connection member 20, and may be screw-coupled to the first connection member screw thread 12 of the first connection member 10 so as to be fastened to the first connection member screw thread 12.

The second connection member 20 may be fitted on the outer side of the metal corrugated pipe P.

The second connection member 20 may be fitted to the outer side of the metal corrugated pipe P in a movable state before being connected to the first connection member 10, and may be fixed to an outer side of one end portion of the metal corrugated pipe P as the second connection member 20 is screw-coupled to the first connection member 10.

Meanwhile, the second connection member 20 may have a tubular shape formed therein with an empty space. The space having a tubular shape inside the second connection member 20 may be referred to as a second connection member inner pipe 21. The metal corrugated pipe P may be inserted into the second connection member inner pipe 21 of the second connection member 20.

Meanwhile, the second connection member inner pipe 21 may be divided into a second connection member inner separationpipe 21a and a second connection member inner close contact pipe 21b according to a separation state from the metal corrugated pipe P.

Meanwhile, the second connection member inner separation pipe 21a may be spaced apart from the metal corrugated pipe when fastenedto the metal corrugated pipe P, and may refer to a space having a diameter that is greater than a diameter of the metal corrugated pipe P.

In addition, the second connection member inner close contact pipe 21b may refer to a space making close contact with the metal corrugated pipe when fastened to the metal corrugated pipe P. In more detail, a diameter of the second connection member inner close contact pipe 21b may correspond to a diameter of the crest P-1 of the metal corrugated pipe P.

Through the above configuration, the second connection member 20 may be supported on the metal corrugated pipe P through the second connection member inner close contact pipe 21b, and the second connection member inner separationpipe 21a may be maintained at a predetermined distance from the metal corrugated pipe P.

Meanwhile, a second connection member inclined surface 24 for connecting the two spaces having mutually different diameters may be formed at a portion where the second connection member inner separationpipe 21a and the second connection member inner close contact pipe 21b are connected to each other. A second connection member perpendicular surface (not shown) may be formed instead of the second connection member inclined surface 24 at the portion where the second connection member inner separationpipe 21a and the second connection member inner close contact pipe 21b are connected to each other. Therefore, the second connection member inclined surface 24 or the second connection member perpendicular surface (not shown) may be formed in the second connection member 20.

Meanwhile, the metal packing 30 and the separation prevention ring 50 may be located in a separation space between the metal corrugated pipe P and the second connection member inner separation pipe 21a.In addition, a part of the first connection member 10 may be screw-coupled to the second connection member 20.

The metal packing 30 may be formed of a metal material, and may serve to fill a gap between the metal corrugated pipe P and the first connection member 10. An inner diameter of the metal packing 30 may be greater than an outer diameter of the metal corrugated pipe P by 1 nti or less, and the outer diameter of the metal packing 30 may be smaller than the first connection member inner guide straight pipe 11c by 1 mm or less. The pipe-reducing and the airtightness may not be possible outside the above tolerance.

The metal packing 30 may be formed of at least one of copper, aluminum, and stainless steel materials, and is preferably foamed of the copper material.

Since copper has a melting temperature of 1084.6° C. as compared with an aluminum alloy having a melting temperature of 463 to 671° C. and general aluminum having a melting temperature of 660 r, the copper may have an excellent heat resistance in withstanding a high-temperature gas. Meanwhile, regarding the stainless steel, 18Cr-based stainless steel may have a melting temperature of 1427 to 1510° C., and 18-18-based stainless steel may have a melting temperature of 1400 to 1454° C.

A brass material may be used as the copper material. Brass is preferably 7/3 brass (brass in which copper and zinc are mixed with each other in a ratio of 7:3). The brass has a beautiful color, is casted more easily than pure copper, has high hardness and strength, has abundant malleability and ductility, and is used to easily fabricate a thin foil or a fine wire.Meanwhile, the 7/3 brass is a uniform a solid solution, and the 7/3 brass is soft with abundant ductility, so that the 7/3 brass may be machined with a cold work.

Meanwhile, the metal packing 30 may be formed in a tubular shape formed therein with an empty space, and an inner space diameter of the metal packing 30 may correspond to the diameter of the crest P-1 of the metal corrugated pipe P.

In more detail, the metal packing 30 may have a tubular shape, and both ends of the metal packing 30 in a longitudinal direction may be referred to as a metal packing first end portion 32 and a metal packing second end portion 34, respectively.

Meanwhile, the metal packing 30 may be coupled to the outer side of the metal corrugated pipe P. In this case, the coupling may be performed such that the metal packing first end portion 32 of the metal packing 30 is directed toward the metal corrugated pipe end portion P-e.

Meanwhile, the separation prevention ring 50 may be coupled to roots P-2 that are adjacent to the metal packing first end portion 32 and the metal packing second end portion 34 of the metal packing 30 to prevent the metal packing 30 from moving in a longitudinal direction of the metal corrugated pipe P toward the second connection member 20. This is to prevent the metal packing 30 from moving before coupling the metal corrugated pipe P to the first connection member 10 and the second connection member 20 so that a smooth coupling operation may be performed.

Hereinafter, a coupling scheme of the connection structure of the metal corrugated pipe according to an embodiment of the present invention will be described in detail.

First, as shown in FIGS. 1 and 2, a coupling preparation process may be performed.

First, the metal packing 30 may be coupled at a position that is adjacent to the metal corrugated pipe end portion P-e of the metal corrugated pipe P. In this case, the coupling may be performed such that the metal packing first end portion 32 of the metal packing 30 is directed toward the metal corrugated pipe end portion P-e, and the metal packing second end portion 34 of the metal packing 30 is directed toward an opposite side of the metal corrugated pipe end portion P-e. The separation prevention ring 50 may be coupled to the root P-2 that is adjacent to the metal packing second end portion 34 of the metal packing 30 to prevent the metal packing 30 from moving in the longitudinal direction of the metal corrugated pipe P.

Next, the second connection member 20 may be coupled to the metal corrugated pipe P. The second connection member 20 may be inserted through an end portion on an opposite side of the metal corrugated pipe end portion P-e. In this case, the second connection member 20 may be coupled such that the second connection member inner separation pipe 21a is directed toward the metal packing 30. In other words, the second connection member 20 may be coupled such that the second connection member inner separation pipe 21a is directed toward the metal corrugated pipe end portion P-e to allow the second connection member screw thread 22 to be directed toward the metal corrugated pipe end portion P-e.

Next, the first connection member 10 may be located such that the first connection member inner guide straight pipe 11c and the first connection member inner inclined pipe 11b are directed toward the metal corrugated pipe end portion P-e of the metal corrugated pipe P.

Thereafter, as shown in FIGS. 5 and 6, the first connection member 10 and the second connection member 20 may be coupled to each other.

First, the metal corrugated pipe end portion P-e of the metal corrugated pipe P may be inserted into the first connection member inner guide straight pipe 11c and the first connection member inner inclined pipe 11b, and the first connection member screw thread 12 formed on the first connection member 10 may be fastened and coupled to the second connection member screw thread 22 formed on the second connection member 20. When the second connection member 20 rotates with respect to the first connection member 10, the first connection member 10 may gradually move toward the second connection member 20 through the screw-coupling.

In this case, when the second connection member 20 moves for a certain range, the metal packing 30 and the metal corrugated pipe P may also move toward the first connection member 10 together with the second connection member 20.

Meanwhile, the metal packing 30 may not be pushed from the metal corrugated pipe P by the separation prevention ring 50, and the metal packing 30 may have a diameter that is gradually reduced according to shapes of the first connection member inner guide straight pipe 11c and the first connection member inner inclined pipe 11b by a coupling force of the first connection member 10 and the second connection member 20. In this case, since the first connection member inner guide straight pipe 11c and the first connection member inner inclined pipe 11b have straight or curved surface shapes, the metal packing 30 may also be pipe-reduced to form a curved surface.Accordingly, the metal packing first end portion 32 that is first inserted into the first connection member inner guide straight pipe 11c and the first connection member inner inclined pipe lib may have a relatively small diameter as compared with the metal packing second end portion 34 that will be inserted later. A sectional shape of the metal packing 30 that has been pipe-reduced may correspond to sectional shapes of the first connection member inner guide straight pipe 11c and the first connection member inclined surface 14 of the first connection member inner inclined pipe 11b. In more detail, abending degree of the metal packing 30 that has been pipe-reduced may correspond to the curvature of the first connection member inclined surface 14.

In addition, the metal corrugated pipe end portion P-e of the metal corrugated pipe P may also have the crest P-1 and the root P-2 having diameters reduced to form a curved surface by the metal packing 30 that is pipe-reduced to form the curved surface. A sectional shape of the metal corrugated pipe P that has been pipe-reduced may also correspond to the sectional shape of the metal packing 30 that has been pipe-reduced. In this case, a height difference between the crest P-1 and the root P-2 may become small as the metal corrugated pipe P is pipe-reduced. In addition, a distance between the crest P-1 and the crest P-1 may be increased, and a distance between the root P-2 and the root P-2 may be increased. Further, a length of the metal corrugated pipe P may be increased, so that the metal corrugated pipe end portion P-e may be deeply inserted into the first connection member inner pipe 11 of the first connection member 10.

When the coupling is completed, as shown in FIGS. 5 and 6, an outer side of the metal packing 30 may make contact with the first connection member inner guide straight pipe 11c and the first connection member inclined surface 14 of the first connection member inner inclined pipe 11b, and an inner side of the metal packing 30 may make contact with the crest P-1 of the metal corrugated pipe P.

Meanwhile, the metal packing 30 and the root P-2 of the metal corrugated pipe P may be maintained in a separation state. In this case, an elastic packing (not shown) may be additionally located between the metal packing 30 and the root P-2 of the metal corrugated pipe P. However, since a coupling force between the metal packing 30 and the metal corrugated pipe P may be sufficient even when the elastic packing (not shown) is not provided, the elastic packing (not shown) may be provided depending on selections of those skilled in the art.

Meanwhile, the metal packing 30 preferably has a relatively thick thickness as compared with a thickness of an outer wall of the metal corrugated pipe P. In addition, the metal packing 30 preferably has relatively low strength as compared with the outer wall of the metal corrugated pipe P. The metal packing 30 may have low strength so that the metal packing 30 may easily make close contact with the outer side of the metal corrugated pipe P when a rotational force is applied to the first connection member 10 while coupling the metal corrugated pipe P to the metal packing 30 and the first connection member 10.

According to one aspect of the present disclosure, a thickness of the metal packing 30 may be maintained overan entire area thereof when compressed by the first connection member inclined surface 14. In addition, the metal corrugated pipe P may be pipe-reduced instead of thinning the end portion of the metal packing, so that a heat resistance may be improved over the entire area of the metal packing 30.

Meanwhile, a friction surface may be formed on a cut surface of the metal packing, the separation prevention ring, and the second connection member inclined surface.

The metal packing 30 may be inserted into the first connection member (10) inclined surface so as to be pipe-reduced as the first connection member 10 is pulled toward the separation prevention ring 50 based on the separation prevention ring by rotating the second connection member 20 coupled to the metal corrugated pipe P. In this case, a pipe-reducing force may be caused by a rotational force of the second connection member 20 to primarily pipe-reduce the metal packing 30 and secondarily pipe-reduce the metal corrugated pipe P, so that the first connection member 10, the metal packing 30, and the metal corrugated pipe P may strongly make close contact with each other.

Hereinafter, effects of the connection structure of the metal corrugated pipe according to one aspect of the present disclosure will be described in detail through the following Examples, Comparative Examples, and Experimental Examples.

### EXAMPLES 1 to 3 AND COMPARATIVE EXAMPLES 1 and 2

### Fastening of Connection Structure of Metal Corrugated Pipe Including First Connection Member having Inner Inclined Surfaces with Mutually Different Curvatures

According to the following procedure, connection structures of metal corrugated pipes according to Examples 1 to 3 and Comparative Examples 1 and 2 including first connection members having inner inclined surfaces with mutually different curvatureswere fastened.

First connection member preparation step S10: The first connection member 10 was prepared to include the first connection member inner straight pipe 11a, and the first connection member inner guide straight pipe 11c and the first connection member inner inclined pipe 11b, which have a tapered sectional shape, such that a section of the inner wall of the first connection member inner inclined pipe 11b has a curvature shown in Table 1 below.

Metal corrugated pipe preparation step S20: The metal corrugated pipe P was prepared to have a thickness of 0.5 mm or less so that the crest P-1 and the root P-2 are formed in the metal corrugated pipe P to allow the metal corrugated pipe P to be easily bent at an angle.

Second connection member preparation step S30: The second connection member 20 was prepared to have an inner space divided into the second connection member inner separation pipe 21a and the second connection member inner close contact pipe 21b according to the separation state from the metal corrugated pipe P, such that the second connection member inclined surface 24 is formed at the portion where the second connection member inner separation pipe 21a and the second connection member inner close contact pipe 21b are connected to each other, and a friction surface is formed on the second connection member inclined surface 24.

Metal packing preparation step S40: The metal packing 30 was prepared so as to be larger than an outer diameter of the crest P-1 of the metal corrugated pipe P and smaller than the first connection member inner guide straight pipe 11c, such that the metal packing 30 is formed of a copper material with a thickness of 2mm or less so as to have low strength as compared with the metal corrugated pipe P, and friction surfaces are formed at both ends of the metal packing 30.

Separation prevention ring preparation step S50: The separation prevention ring 50 was prepared so as to be fitted into the root P-2 of the metal corrugated pipe P, such that a friction surface is formed on an outer surface of the separation prevention ring 50.

Metal corrugated pipe connection structure fastening preparation step S60: After the second connection member 20 is coupled to the metal corrugated pipe P, the separation prevention ring 50 was coupled to the metal corrugated pipe P. Thereafter, the metal packing was fitted to the metal corrugated pipe P. Meanwhile, the first connection member 10 was located such that the first connection member inner guide straight pipe 11c and the first connection member inner inclined pipe 11b are directed toward the metal corrugated pipe P.

Metal corrugated pipe connection structure fastening step S70: The connection structure of the metal corrugated pipe was fastened by fitting the metal corrugated pipe P into the first connection member inner guide straight pipe 11c and the first connection member inner inclined pipe 11b of the first connection member 10, and by screw-coupling the second connection member 20 to the first connection member 10 while strongly rotating the second connection member 20.

TABLE 1

| | Compar- | | | | Compar- |
|---|---|---|---|---|---|
| | ative | Exam- | Exam- | Exam- | ative |
| | Example 1 | ple 1 | ple 2 | ple 3 | Example 2 |
| Curvature (κ) of | 0.000001 | 0.00001 | 0.003 | 0.005 | 0.007 |
| section of inner wall | | | | | |
| of first connection | | | | | |
| member inner in- | | | | | |
| clined pipe | | | | | |

### COMPARATIVE EXAMPLE 3

### Fastening of Connection Structure of Metal Corrugated Pipe Including First Connection Member having Inner Inclined Surface Formed in Straight-Line Shape

The same processes as in Examples 1 to 3 and Comparative Examples 1 and 2 were performed, while the first connection member preparation step S10 was applied differently.

First connection member preparation step S10: The first connection member was prepared to include the first connection member inner straight pipe and the first connection member inner inclined pipe that has a tapered sectional shape, such that a section of the inner wall of the first connection member inner inclined pipe has a straight-line shape.

### COMPARATIVE EXAMPLE 4

### Fastening Of Connection Structure Of Metal Corrugated Pipe in Which Friction Surface is not Formed on End Surface of Metal Packing, Separation Prevention Ring, and Second Connection Member Inclined Surface

The same processes as in Examples 1 to 3 and Comparative Examples 1 and 2 were perfoLmed, while the second connection member preparation step S30, the metal packing preparation step S40, and the separation prevention ring preparation step S50 were applied differently as follows.

Meanwhile, the sectionof the inner wall of the first connection member inner inclined pipe of the first connection member had a curvature of 0.00001 as in Example 1.

Second connection member preparation step S30: The second connection member 20 was prepared to have an inner space divided into the second connection member inner separation pipe 21a and the second connection member inner close contact pipe 21b according to the separation state from the metal corrugated pipe P, such that the second connection member inclined surface 24 is formed at the portion where the second connection member inner separation pipe 21a and the second connection member inner close contact pipe 21b are connected to each other, and a friction surface is not formed on the second connection member inclined surface 24.

Metal packing preparation step S40: The metal packing 30 was prepared to have an inner diameter that matches an outer diameter of the crest P-1 of the metal corrugated pipe P, such that the metal packing 30 is formed of a copper material with a thickness of 2 mm or less so as to have low strength as compared with the metal corrugated pipe P, and friction surfaces are not formed at both ends of the metal packing 30.

Separation prevention ring preparation step S50: The separation prevention ring 50 was prepared so as to be fitted into the root P-2 of the metal corrugated pipe P, such that a friction surface is not formed on an outer surface of the separation prevention ring 50.

### EXPERIMENTAL EXAMPLE 1

### Examination of Gas Leakage Prevention and Close Contact Strength

For Examples 1 to 3 and Comparative Examples 1 to 4, gas leakage prevention and close contact strength were examined.

First, an experiment on the gas leakage prevention was performed.For the connection structures of the metal corrugated pipes prepared in Examples 1 to 3 and Comparative Examples 1 to 4, another metal pipewas coupled to an opposite side of the first connection member to which the metal corrugated pipe was connected, and an LPG gas was transferred inside the connection structure of the metal corrugated pipe.A glass wall was installed to block and seal the connection structure of the metal corrugated pipe from an outside, and a gas detector was installed inside the glass wall to examine a gas leakage amount over 24 hours.The gas leakage amount was measured by using a combustible gas measurement device (leakage amount measurement) of XP-3160, which is a portable gas detector.

Next, an experiment on the close contact strength between the first connection member and the metal packing, and the metal corrugated pipe was performed. For the connection structures of the metal corrugated pipes prepared in Examples 1 to 3 and Comparative Examples 1 to 4, after the second connection member is separated, the first connection member was suspended from a ceiling, a link was installed on the metal corrugated pipe, and a weight of 100 g was sequentially placed on the link so as to measure a weight at which the first connection member is separated from the metal corrugated pipe. Results are as shown in Table 2 below, in which it was determined as being adequate for use when a gas leakage rate (ppm) over 24 hours is less than 0.2 ppm, and it was determined as being inadequate for use when the gas leakage rate (ppm) over 24 hours is greater than or equal to 0.2 ppm. In addition, the close contact strengthwasdetermined as being adequate when the weight at which the first connection member is separated from the metal corrugated pipe is 12,000 g or more, and the close contact strength was determined as being inadequate when the weight at which the first connection member is separated from the metal corrugated pipe is 12,000 g or less.

Comprehensive evaluation was performed such that usability is evaluated as being adequate when all criteria are met, and the usability is evaluated as being inadequate when even one criterion is not met.

TABLE 2

| | Gas | | Weight (g) at which | | |
|---|---|---|---|---|---|
| | leakage | Gas | first connection | Close contact | |
| | rate (ppm) | leakage | member is separated | strength | |
| | over 24 | adequacy | from metal | adequacy | Comprehensive |
| | hours | determination | corrugated pipe | determination | evaluation |
| Example 1 | 0.18 | Adequate | 13,600 | Adequate | Adequate |
| Example 2 | 0.15 | Adequate | 12,800 | Adequate | Adequate |
| Example 3 | 0.12 | Adequate | 12,300 | Adequate | Adequate |
| Comparative | 0.23 | Inadequate | 13,900 | Adequate | Inadequate |
| Example 1 | | | | | |
| Comparative | 0.11 | Adequate | 11,500 | Inadequate | Inadequate |
| Example 2 | | | | | |
| Comparative | 0.23 | Inadequate | 14,100 | Adequate | Inadequate |
| Example 3 | | | | | |
| Comparative | 0.25 | Inadequate | 9,800 | Inadequate | Inadequate |
| Example 4 | | | | | |

As a result, when the section of the inner wall of the first connection member inner inclined pipe has a curvature of 0.00001 to 0.005, it was found that both gas leakage prevention performance per unit time and the close contact strength between the first connection member and the metal packing, and the metal corrugated pipe are adequate for use.

Generally, it was found that the gas leakage prevention performance per unit time becomes higher as the curvature becomes larger, and the close contact strength between the first connection member and the metal packing, and the metal corrugated pipe becomes higher as the curvature becomes smaller. Both criteria were satisfied when the section of the inner wall of the first connection member inner inclined pipe has the curvature of 0.00001 to 0.005.

Meanwhile, it was found that the connection structure of the metal corrugated pipe including the first connection member having the inner inclined surface formed in a straight-line shape has reduced gas leakage prevention performance.

In addition, it was found that in a case of the connection structure of the metal corrugated pipe in which the friction surface is not formed on the end surface of the metal packing, the separation prevention ring, and the second connection member inclined surface, both the gas leakage prevention performance and the close contact strength between the first connection member and the metal packing, and the metal corrugated pipe are significantly reduced.

### COMPARATIVE EXAMPLES 4 TO 6

### Preparation of Packing with Different Materials

The metal packing preparation step S40 was applied differently to prepare packings according to Comparative Examples 4 to 6.

Packing preparation step S40: The packing was prepared such that the packing is formed of a material shown in Table 3 below with a thickness of 2 mm or less, and friction surfaces are formed at both ends of the packing.

TABLE 3

| | Comparative | Comparative | Comparative |
|---|---|---|---|
| | Example 4 | Example 5 | Example6 |
| Material of | Aluminum alloy | Aluminum | Silicone |
| metal packing | (Al—Cu—Mg) | | rubber |

### EXPERIMENTAL EXAMPLE 2

### Examination of Heat Resistance

For the metal packing formed of the copper material prepared in Example 1 and the packings according to Comparative Examples 4 to 6, a heat resistance was examined.

The packings according to Example 1 and Comparative Examples 4 to 6 were placed in a heating furnace, and a temperature at which a shape is deformed was measured while gradually increasing a temperature. Results are as shown in Table 4 below.

TABLE 4

| | Temperature at which shape |
|---|---|
| | starts to deform (° C.) |
| Example 1 | 942 |
| Comparative Example 4 | 463 |
| Comparative Example 5 | 470 |
| Comparative Example 6 | 235 |

—

As a result, it was found that an excellent heat resistance is achieved when the copper material is used for the preparation.

The connection structure of the metal corrugated pipe according to one aspect of the present disclosure was examined through Examples, Comparative Examples, and Experimental Examples.

According to the connection structure of the metal corrugated pipe of one aspect of the present disclosure, the first connection member inner guide straight pipe and the first connection member inner inclined pipe of the first connection member have diameters reduced to form curved surfaces in an inward direction in which the metal corrugated pipe is inserted. It was found that Examples 1 to 3 and Comparative Examples 1 and 2 in which the diameter is reduced to form a curved surface have excellent gas blocking capability as compared with Comparative Example 3 in which the diameter is reduced only in a linear direction.

Meanwhile, according to the connection structure of the metal corrugated pipe of one aspect of the present disclosure, it was found that the gas leakage prevention and the close contact strength are simultaneously satisfied when the section of the first connection member inclined surface has the curvature of 0.00001 to 0.005.

In addition, according to the connection structure of the metal corrugated pipe of one aspect of the present disclosure, it was found that the excellent heat resistance is achieved with softness as silicone or the like because the metal packing is formed of the copper material.

Accordingly, according to one aspect of the present disclosure, a connection structure of a metal corrugated pipe having improved gas leakage prevention, improved close contact strength, and an excellent heat resistance has been developed.

Although the present disclosure has been described with reference to the accompanying drawings, the above description corresponds to only one embodiment among various embodiments including the gist of the present disclosure, which aims to enable a person having ordinary skill in the art to easily implement the present disclosure, so that the present disclosure is not limited to the embodiments described above. Therefore, the scope of the present disclosure is to be interpreted by the appended claims, and construed as encompassing all technical ideas within the scope of equivalents thereof by changes, substitutions, alternatives, and the like without departing from the gist of the present disclosure.In addition, some elements in the drawings may be exaggerated or reduced as compared with actual elements so as to more clearly describe the elements.

What is claimed is:

1. A connection structure of a metal corrugated pipe, the connection structure comprising:
a first connection member including a first connection member screw thread formed on one side of an outer peripheral surface of the first connection member, and including a first connection member inner guide straight pipe and a first connection member inner inclined pipe, which are formed on an inner side of a region in which the first connection member screw thread is formed;
the metal corrugated pipe inserted into the first connection member inner guide straight pipe and the first connection member inner inclined pipe of the first connection member;
a second connection member fitted on an outer side of the metal corrugated pipe, screw-coupled to the first connection member, and including a second connection member screw thread, and a second connection member inclined surface or a second connection member perpendicular surface, which are foamed on an inner side of the second connection member;
a metal packing fitted on the outer side of the metal corrugated pipe, and inserted into the first connection member inner guide straight pipe and the first connection member inner inclined pipe so as to be pipe-reduced to form a curved surface; and
a separationprevention ring fitted in a rootformed on the outer side of the metal corrugated pipe, and configured to fix the metal packing to prevent the metal packing from being separated.

2. The connection structure of claim 1, wherein the metal packing is formed of a metal material including copper.

3. The connection structure of claim 1, wherein the first connection member inner guide straight pipe and the first connection member inner inclined pipe of the first connection member have diameters reduced to form curved surfaces in an inward direction in which the metal corrugated pipe is inserted.

4. The connection structure of claim 1, wherein a first connection member guide straight surface and a first connection member inclined surface are formed on inner walls of the first connection member inner guide straight pipe and the first connection member inner inclined pipe, respectively.

5. The connection structure of claim 1, wherein the metal packing is inserted into the first connection member inner guide straight pipe and the first connection member inner inclined pipe so as to have a diameter reduced to form the curved surface.

6. The connection structure of claim 1, wherein the metal corrugated pipe has a diameter reduced to form a curved surface by the metal packing that is pipe-reduced to form the curved surface.

7. The connection structure of claim 1, wherein a friction surface is formed on an end surface of the metal packing, the separation prevention ring, and the second connection member inclined surface, so that the metal packing is inserted into a first connection member inclined surface so as to be pipe-reduced as the first connection member is pulled toward the separation prevention ring based on the separation prevention ring by rotating the second connection member.
